(19) United States
(12) Patent Application Publication
(10) Pub. No.: US 2007/0145843 A1
(43) Pub. Date: Jun. 28, 2007

(54) Fly rotor motor

(76) Inventor: Martin W. Olson, St. Louis Pk, MN (US)

Correspondence Address: Martin Olson, 4161 Meadowbrook Ln #217, St. Louis Pk, MN, 55426, US

(21) Appl. No.: 11/319,147

(22) Filed: Dec. 27, 2005

(51) Int. Cl. H02K 5/16

(52) U.S. Cl. 310/90

(57) ABSTRACT

This invention, the Fly Rotor Motor, is an electric motor that turns a shaft and induces force on an object, or counter force, on an object that said invention is attached to or is in contact with. This invention achieves this by the use of a coil, or coils circumvented around the rotor, which induces a strong magnetic field on at least two poles of a hollow metal cylinder shaped rotor (2), which is circumferenced around a set of ball bearings. The magnetic field would pull and stretch a hollow metal rotor cylinder while at the same time the rotor cylinder is retracting back to its original shape. The rotor would absorb much energy then release this energy from constantly retracting. This energy, from constant retracting, would be released through a set of ball bearings (4) down to a shaft to be turned. The energy, being absorbed from the magnetic forces constantly pulling a retracting rotor cylinder (2), is being released into the ball bearings (4) and compounded, through the retracting of the energized ball bearings. The energy is absorbed and released into a lower bearing ring (6). Then, as the lower bearing ring is retracting from being pressured, the energy is compounded further as the energy is released into the shaft (5). The shaft (5) has not only enough energy to turn at high rpm but also become a medium of force against the housing. The housing (10) takes this force and transfers it into a force against any object or force outside the device. The shaft (5) can also be fixed to the housing so that it cannot be moved, allowing the housing to become a greater force on any outside object.

### BACKGROUND 1. Field of Invention

This invention, the Fly Rotor Motor, is a new kind of electric motor. It is unique in that it produces an action force upon any object the invention is attached to or any counter force coming against it. This action force is coming from the outside of the device and not from a spinning shaft.

At this point I would like to refer to the Fly Rotor Motor as the FRM.

This motor or FRM also, like all electric motors turns a shaft, but what makes this invention unique is that this device not only turns a shaft but can push or pull objects that are connected or near the device. The FRM creates a physical impedance, or resistance, for any device that creates motion.

2. Description of Prior Art

A turbo jet, by the propulsion of hot air, is able to push itself against a physical body, an air plane, to push an airplane into the air. Therefore, a turbo-jet engine is a motor that creates external energy on another object outside itself and therefore be considered prior art. This invention doesn't take up as much room as turbo jet engine and doesn't require expensive jet fuel.

Another prior art device is part of Robert Goddard's' patent of a Rocket Apparatus; U.S. Pat. No. 1,102,653. In Gaddard's rocket apparatus there is a series of rotating disks contained in what looks like the top part of his rocket. Each disk is cut into sections that span around the hub, which is simply a fixed shaft running through the center. Each section is bordered by a gap. This gap is filled with a solid explosive element and each of these gaps, inserted between each section, is electrically wired to detonate in a consecutive manor. The explosions cause the disks to rotate quickly and create a force, much like the FRM, that resists the speeding rocket's tendency to veer into different directions instead of pushing upwards in a straight line. Here you have a force of the rotor disk, powered by explosives, fighting against the force of a speeding rocket and its tendencies to go wayward in other directions which would lead to undesirable consequences.

The difference between Gaddard's disks and the my invention is; where my invention uses compressed lines of magnetic force to turn a rotor; Gaddard's invention uses solid explosives and, of course, there is no turning of a shaft in Gaddard's disks. However the similarities are strong as far as creating a force from a spinning rotor to induce a force on another object.

The principal behind this invention is this; when the shape of a metal object is distorted by a force, that metal object will absorb the energy that distorted it and release energy while retracting to its original shape. The stronger the force, the quicker the distortion on the object, the greater the energy released by the object retracting to its original shape.

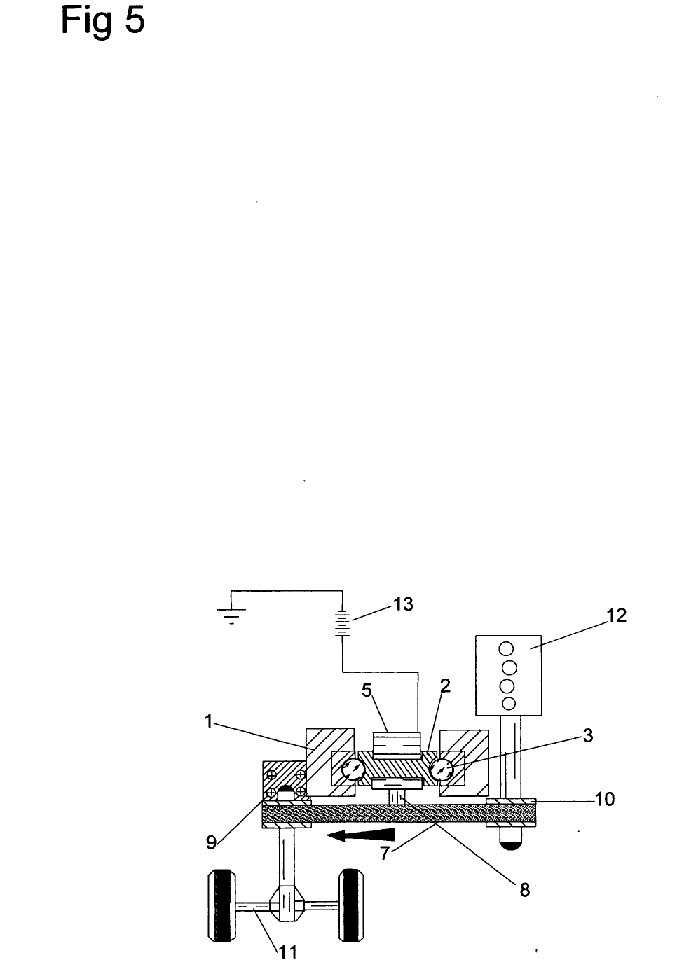

One can see this principal of operation at work in all chain driven machinery. When running at high speed around an engine pulley and the rear axle. This mechanism distorts the chain by pulling on it. The chain releases energy, pushing outward from the engine and the axle, while regaining its original shape. In a chain driven machine or vehicle, so much energy is absorbed in the chain. After being distorted by the gear wheels, or pulley wheels, the chain absorbs energy and releases it as it re-shapes itself, and in doing so pushes itself out creating a bow shape. The gear wheels are already energized and turning so there is no place for the chain's energy to go accept into and out of the chain links, which are pushing against each other while retracting back to there original shape. Therefore, a chain driven vehicle would never keep much momentum beyond a certain speed which is about 30 mph. This is why one never sees chain driven vehicles any more, even though a chain-drive transmission is best for starting from a stand-still position. Now, of course, we have synchro-mesh gear systems. Synchro-mesh transmissions and fluid transmissions are bulky and heavy. Because of the FRM one can return to lighter, stronger and more fuel efficient chain or belt drive transmission. This will be shown in FIG. 5 along with a description. With the FRM a hollow rotor cylinder becomes energized, absorbing energy and releasing it through ball bearings where the energy is transmitted to a shaft. Through this process the device releases some energy by turning a shaft and much of the energy to push and pull other items, or what ever counter force put in front of it.

Another prior art would be todays conventional electric motors; such as the AC synchronous, the DC motor and the stepper motor. First of all, none of these motors generates a pushing or pulling energy outside itself.

Secondly, the rotors in todays conventional electric motors pulls a weighted shaft directly. This makes more work for the motor and requires more magnetic flux lines to turn a shaft. The FRM stator turns a hollow cylinder that rotates a set of bearings. The bearings absorb energy from said hollow cylinder and releases that energy on to another hollow cylinder that turns the loaded shaft. In this invention, the flux lines from the stator only turn a hollow cylinder. This requires less energy and fewer coil turns, also less heat generation. Therefore, one has a lighter, less bulky and more efficient motor. With fewer coil turns required one can build a much smaller motor but with the same power as a bigger motor. This means one can bring more power to smaller tools such as dental drills and small sculpting tools. With todays dental tools or sculpting tools one needs to be hooked up to a large air compression generator. A miniaturized FRM would also be very useful as a way to replace spring cushions in todays beds or even chairs. Today there is a huge market for couches and sofas designed with orthopedic therapy in mind. If one could line up a large number of FRMs (miniaturized), in a recliner chair or mattress, one would have a padding that returns a perpendicular force to almost every inch of ones body. This would induce the body's muscles to distribute themselves for greater comfort. An equal perpendicular counter force pushing against every square inch of the body would create the sensation of floating on air or floating on water.

### SUMMARY OF INVENTION

This invention does what a turbo-jet engine does. Unlike a turbo-jet engine, this device is smaller and uses no liquid fossil fuels. A jet engine uses jet propulsion to push an object outside itself that is connected to said jet engine. This invention induces a force on an object outside itself from the energy that is absorbed into a hollow metal rotor when rotating at a high speed. When cylinder is distorted by a magnetic force, energy is released and multiplied when hollow cylinder retracts and tries to re-acquire its original shape. This multiplied energy is then transmitted to a set of ball bearings in a bearing ring where more energy is gained. This bulk of energy is transmitted to a lower bearing ring. This bearing ring absorbs this energy and releases it by compressing down on the shaft to turn and twist it to make the shaft spin and create a turning and lifting force on an axle, or outside object simultaneously. Not only does this invention turn a shaft but also gives that shaft the power that we call torque.

This invention can be useful for any machine that requires balance to function properly.

This invention is most useful for engines that require a high physical impedance for a high energy output, such as a transmission system. This device would act as a counter force against another force. The higher the counter force, or impedance, to meet the engine's high energy output, the more energy output will go into turning the drive shaft.

This means more power with less fuel consumption.

Description of Parts

1) Coil
2) Rotor Cylinder
3) Rotor Poles
4) Ball Bearings
5) Shaft
6) Lower Bearing Ring
7) Leads to Regulatory Circuit
8) Power supply
9) Regulatory circuit
10) Housing
11) Shaft bearings

### DESCRIPTION

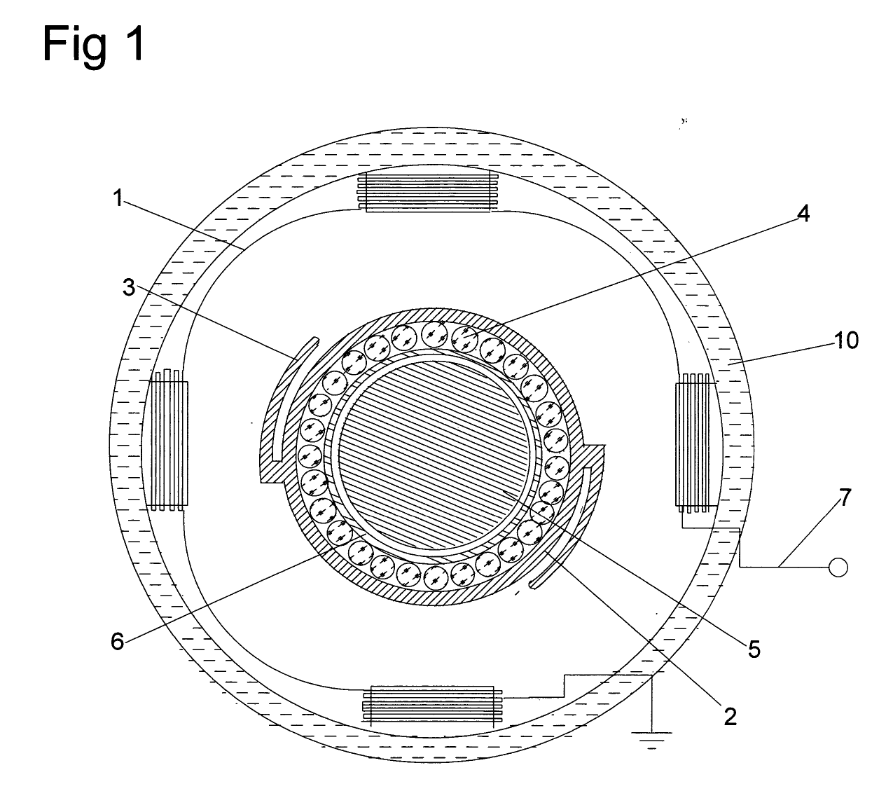

FIGS. 1 & 2 & 3

First consider the four coils (1) facing the rotor. This arrangement is much like the AC synchronous motor. The magnetic fields emanating from the coils (1) will conflict with each other and creating their own impedance and building more energy in these fields. When a coil is energized the flowing current transforms into magnetic lines of force. Every conductor turn in the coil creates a magnetic field traveling from the north end to the south end of the respective element. These fields push out from the coil and also push against each other at the same time.

With a group of coils in a circular distribution scheme, there are hundreds of turns of conductible coil forming thousands of magnetic fields of there own, when induced with a current. Therefore, all these thousands of magnetic fields are going to push against each other with high pressure towards the stators' central inner area. All these fields together seek after an area of least reluctance to move into, and all these magnetic fields compete for space in that area.

In FIG. 1 the rotor cylinder (2) with its two bowed looped shaped rotor poles (3), on opposite ends of each other, give those magnetic lines of force that area of least reluctance. As these flux lines form into a very dense area of magnetic fields competing for space, the energy springing from this small dense area pulls the rotor cylinder (2) on opposite ends stretching it out of shape. The rotor cylinder (2) must retract to its original shape and in doing so release energy. As the coil increases its strength and stretches (energizes) the rotor cylinder (2) at quicker intervals, the faster the rotor cylinder (2) must retract to its original shape and the more energy it would release. As long as the rotor cylinder (2) provides a constant physical impedance (something for the force to constantly pull on), the coil (1) strength would increase.

The body of the rotor cylinder (2), which is basically a hollow steel tube, could be nearly paper thin and could consist of steel or any ferromagnetic material.

With this invention, as the rotor cylinder (2) is retracting to its original shape, the energy released in the form of pressing down on the ball bearings (4).

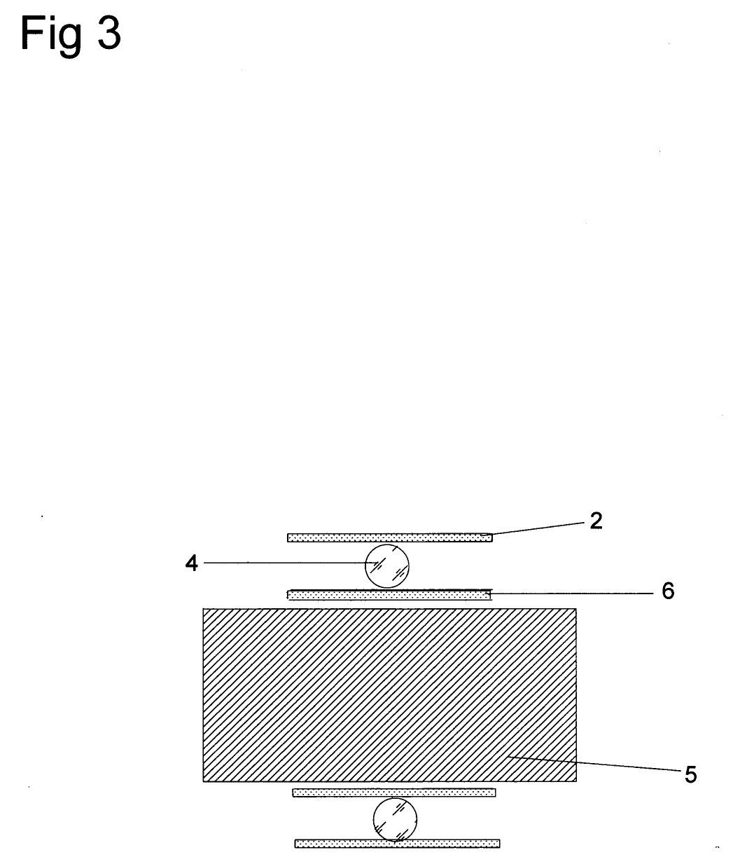

In FIG. 3 the ball bearings (4) size is exaggerated in drawing because after all, the ball bearings (4) are the main transmitters of energy to the lower bearing ring (6), to the shaft (5). There is no specifications for the ball bearing size. In this particular design, the ball bearings are compressed in between the rotor cylinder (2) and the lower bearing ring (6). Also one can arrange to insert one or more radial cylinders between the rotor cylinder (2) and the ball bearing apparatus. This would be to not only better secure the ball bearings but to reinforce the power motion energy of the shaft (5).

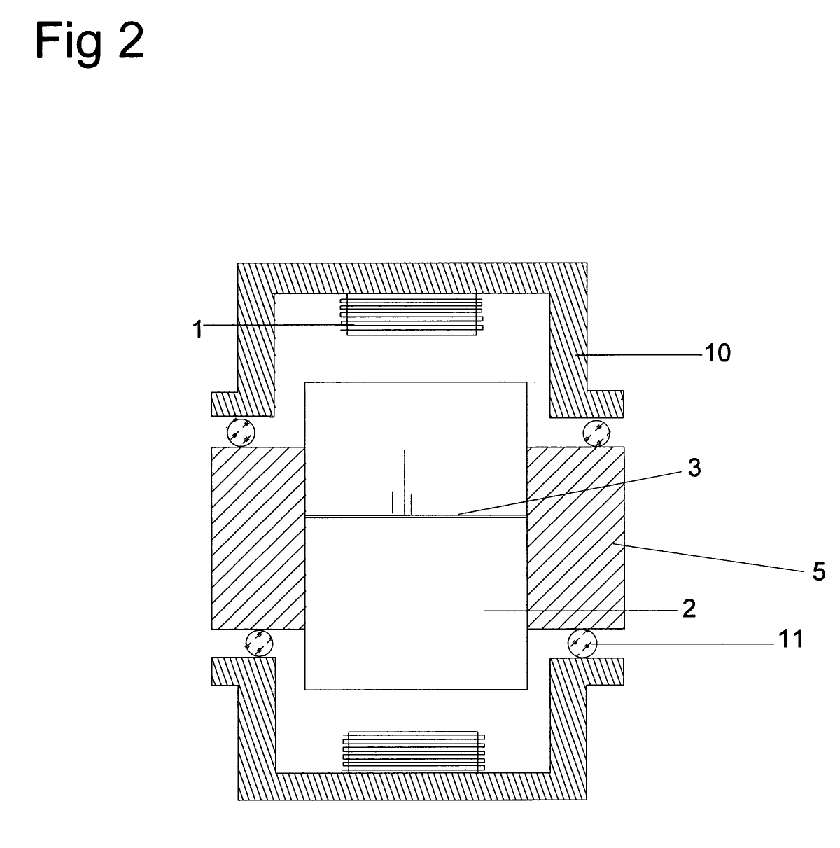

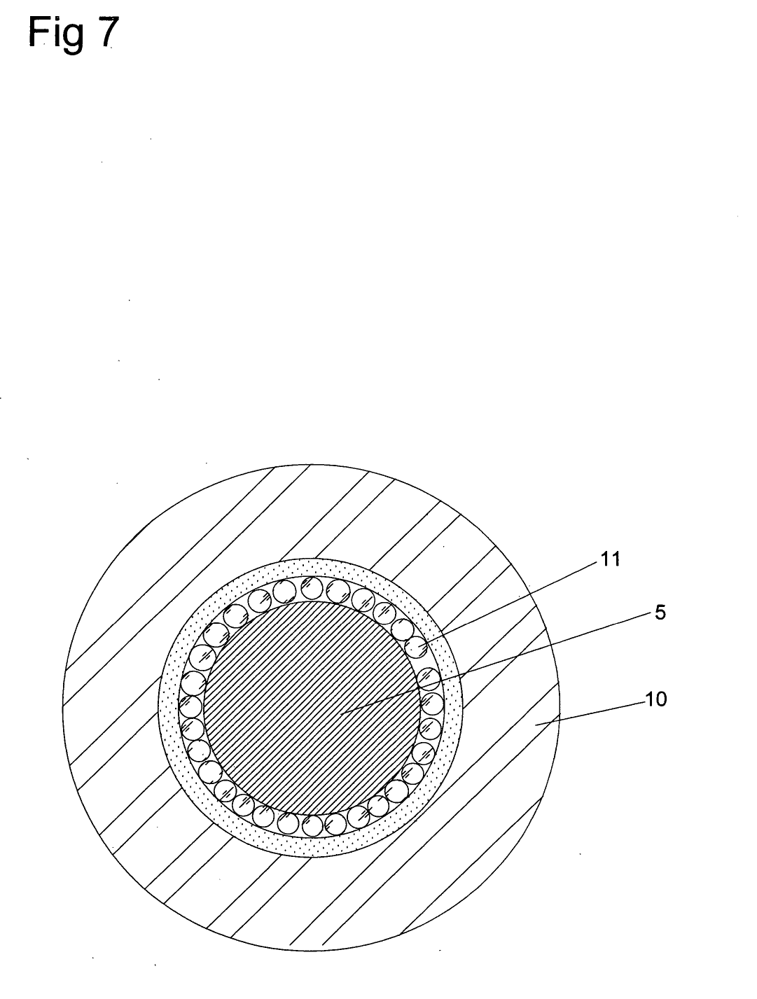

In FIGS. 1 & 3 the ball bearings (4) would transmit this energy to the lower ring (6). This lower ring (6) will press down against the shaft (5) acting like a gripper to compress upon the solid shaft. This energy to compress down upon the shaft (5) would be transmitted from the ball bearings (4). Some of this energy is used to cause the shaft (5) to turn. How much depends on the load on the shaft (5). However, a large amount of this energy pressing down on the shaft (5) from the lower bearing ring (6) is forcing the shaft (5) to press against the shaft bearings (11) (See FIG. 7 and FIG. 2) as it is turning. The shaft bearings (11) would then press against the housing (10). The housing (10) would then be the element that carries the force that would push or pull against any object or counterforce put upon this device. If however, the shaft (5) was welded or fixed on the housing (10) to be permanently still, all the force from the bearings (4) would be concentrated to produce a force on the housing (10).

With an FRM all the energy generated in the device becomes focused upon a point on the housing (10) where the highest physical resistance or pressure coming against the FRM.

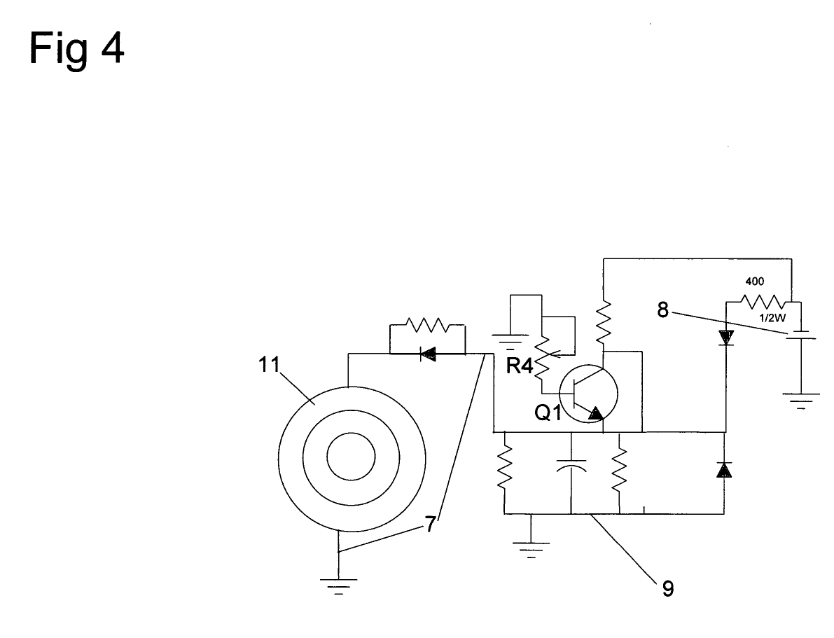

See FIG. 4

In this drawing is a basic chop circuit. In this circuit the Q1 cuts off the flow of current going to the FRM coil (1) for a period of time, a time determined by a potentiometer (R4) at the base of said transistor. The longer this cut-off time period, the shorter the duty cycle of the FRM. This means less force on an object the device is attached to. The shorter cut-off time, of course, means more power on an object the device is attached to.

See FIGS. 5 & 6

### A PRACTICAL EXAMPLE

The following are the parts list;
1) Frame
2) Movable frame
3) Ball Bearings
4) Fly-wheel
5) FRM
6) Lower pulley wheels
7) Belt
8) Shaft from FRM
9) Power Train pulley
10) Engine pulley
11) Power train
12) Engine
13) Power source

The following is a unique transmission system that employs a belt drive, which is similar to a chain drive. A chain drive is the best kind of transmission for quick start ups from a stand still position. This is because a chain, or belt, generates much energy by re-acquiring its original shape when being pulled out of shape by the powered gears or pulleys. This energy, from re-acquiring its shape, is multiplied many times over at the same time because of the number of chain links involved in the process of releasing energy at the same time.

On a belt, the equivalent to the links in a chain would be the carbon-sulfur molecular structures, or rubber molecules, being stretched and releasing energy to regain their shape. With chain drive vehicles, after starting from a standstill has been achieved, much of the energy put into the chain is released back into the chain and a small percent of this energy is left over to turn the axle. When a chain is pulled around two gears the chain's energy is released into each link and these links are releasing this energy by pulling against each other. This is what causes the the chain to bow out away from the two opposing gears that the chain is pulled around. This is what is called creating slack. If one were to add a third gear and stretch the chain out a little you cut out the slack and allow the powered gears to reach a higher speed without any slack. However, as the chain is being pulled harder and absorbing and releasing more energy from the engine, more energy will be released from the chain links (against each other) and new slack will be created. Then one could add a fourth gear, or say forget about a fourth gear and simply make the original two gears larger to stretch the chain even more to exceed an even higher rpm before slack is once again created. The following example can be modified and adapted to todays internal combustion engines which employ a belt drive or chain drive for valve operations and timing and also for automatic transmissions.

In FIGS. 5 & 6 presents an apparatus made up of a belt and pulleys. With an FRM constantly pulling slack out of the belt one may no longer need a belt with teeth because with a constant pulling FRM, that grip between pulley and belt is always there.

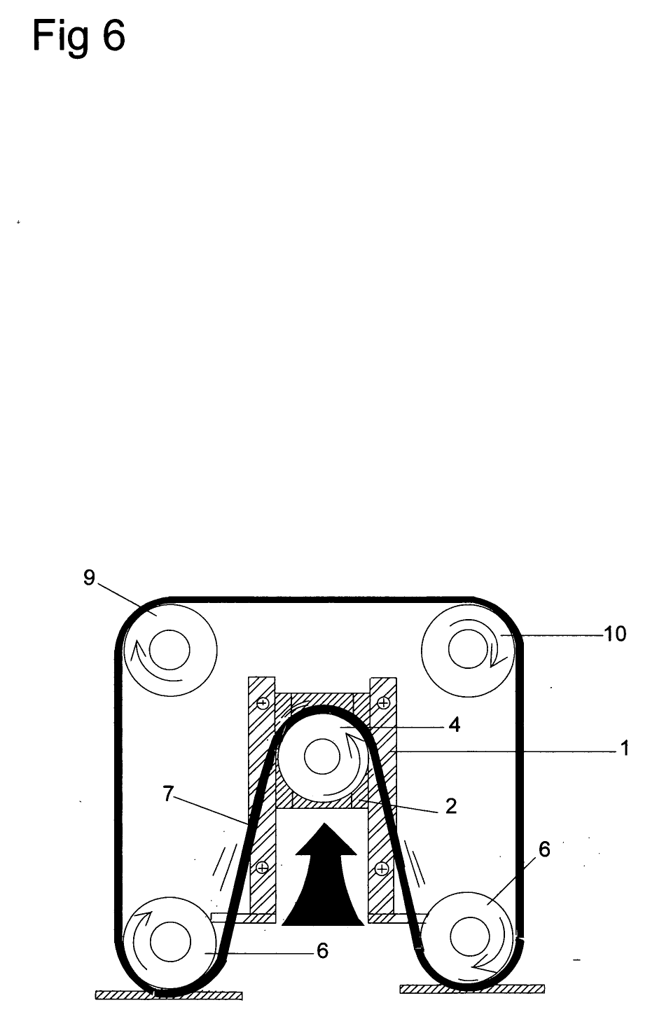

In FIG. 5 is a pulley and belt apparatus. FIG. 6 is the top view. The frame (1) contains the fly rotor motor (5) connected to a flywheel (4) and both are contained in a movable frame (2) that moves along two sets of ball bearings (3) on opposite sides of the frame (2).The FRM flywheel (4) are part of a belt drive scheme that consists of two lower pulleys (6) and the engine drive pulley (10) and the pulley that drives the axle, or power train (9). This is basically an automatic transmission system.

As the engine turns the engine pulley (10) that drives the belt (7), the belt (7) then drives the whole system. The more force is put on the belt by the engine, the more the belt pushes down upon the FRM flywheel (4). Consequently, the more counter force the FRM releases upon the belt while pushing the movable frame (2) and itself upward, as the flywheel (4) pushes harder against the belt. The stronger the belt force the stronger the FRM force. As a result, slack is completely eliminated. The energy released from the rubber molecules structures, of the belt (7), is released against the FRM flywheel (4), not against other opposing molecular structures of the belt (7). Then this energy is distributed to all pulleys. This allows 100% of the engines energy to be used to drive the wheels of the power train (11) through the power train pulley (9). For todays gasoline engines this kind of apparatus would add greater fuel efficiency and more power to the engine.

What one has in the above example, is text-book example of an automatic transmission.

That is an automatic transmission without the fluid pumps, or bulky gears. An automatic transmission system that is light and simple to repair.

Applications

The best applications for this particular invention would be in transportation, such as automobiles or motorcycles. With motorcycles, one can have inexpensive automatic transmission. If one can mount an FRM on a straight shaft, being that the FRM is held in place by roller bearings, and placed in a chain drive with other gears or pulleys such as in FIGS. 5 & 6, the FRM would tighten the chain against the opposing gears progressively tighter as the motorcycle speeds up. More voltage is induced into the FRM, as the engine revs higher. The tighter the chain, the more resistance or physical impedance to the engine. The more physical impedance, the more the engine will perform to mount a counter impedance. Mounting a counter impedance against an engines energy and allow the engine to raise its performance to match this counter impedance is what we have transmissions for in the first place. Without transmissions engines would just overheat and be ruined.

With autos, one could develop transmissions using the same principal as the above motorcycle transmission. With the FRM we could do away with heavy cumbersome and expensive gear driven and fluid driven transmissions. This means no more wet spots on the garage floor which lead to expensive transmission overhauls.

Another great use for this invention is in the physical fitness arena. Since the FRM always resists any physical force that comes against them, one can fit these FRMs on a flexible pole as a barbells. They would resist any lifting force created by the person lifting the weights and would be far less dangerous than actual weights. The reason for this is because the FRMs would cease to create a counter force as soon as the lifter stops creating a force against them. Actual weights are always heavy even when not being lifted and can cause injury to someone if dropped,or choke the person lifting if he or she is careless. In other words, the FRMs can be a strong resistance and still be light.

The FRM makes it possible to spin an axle and create lift on that axle at the same time.

This would give the axle greater power. Not only would one have rotation but also torque. In doing this one would create a slight bow in the axle while its turning. The axle would release even more energy trying to re-straighten itself, creating torque.

The very nature of this invention would lend itself to be a great motor for a garden tiller. While spinning an axle, turns the blades, the tiller would be constantly pushing down into the ground because the FRM constantly pushing against a counter force, this force being the hard ground.

Another great use for such an invention is, in a word, STABILITY. With the coming of robotics, stability is a key word. Example, pick and place machines that pick up electronic components and place them in a board. This machine is being influenced by centrifugal forces every time the machine sets up a part and places into a board. That is, by the way, why these machines are so massive and heavy. The purpose of the this massive weight is to become a force against centrifugal forces while operating. To create STABILITY. The FRM can provide this stability by generating its own force against these other forces. One or several FRMs in a few key places in a robotic machines frame would add stability and these machines don't have to be so heavy. This is especially important now that robots are learning to walk

Another use, as was mentioned earlier in the application, is an electronic cushion spring. Rows and/or squares of these FRMs will always provide a perpendicular upwards directional push. This will not only create a very comfortable chair or bed, but a kind of platform that one can drop heavy boxed materials without damaging the materials.

1. I claim;
an electric motor wherein the rotor is a metal member which rotates freely around a first member, this could be a circular set of ball bearings,
a) said rotor is the only metal member in contact with the magnetic flux lines from the stator,
b) said rotor is producing a force upon said first member causing said first member to rotate and produce a force upon a second member and causes said second member to rotate, said second member can be a metal cylinder shape,
c) said second member rotates around a third member and has a frictional relationship with said third member, third member can be a central shaft for turning, said second member presses upon said third member and causes said third member to turn with said second member,
d) intense contact during rotation between said rotor and said first member, which may be a circular ball bearing set, will contribute a means of force to said second member to press upon said third member, center of all rotating members, causing said third member to rotate,
d) this intense contact, starting from said rotor on down through the said members, would be caused by gradual increase of magnetic lines of force from the stator.

2. I claim;
an electric motor that by its own action creates a force upon an object that said electric motor is attached to without using a shaft to turn an apparatus.

3. I claim an electric motor with a rotor that rotates around a circular member causing said circular member to rotate and said circular member causing the rotation of a second circular member underneath said circular member and beneath said second circular member a third circular member that rotates due to the force induced by said second circular member, at the center of all rotating members is a round shaft of which is turned by the combined energies of all rotating members.

4. The arrangement of claim 1 wherein said round bearing ring is of a polymer material and has concave seats cut into the outer side, side of said bearing ring that faces said metal rotor cylinder, and a flat surface on the inner side of said round bearing ring, these said concave seats would hold in place metal ball bearings and polymer ball bearings while the inner side would be fixed to said shaft that turns a load.

5. The arrangement of claim 1 wherein a member, cylinder shaped and circumferences around said first member, has a frictional relationship with said rotor and is inserted between said rotor, which could be a metal cylinder, and said first member which could be a set of ball bearings and
a) more than one said cylinder shaped members is inserted between said rotor and said first member, which can be a set of ball bearings.

6. The arrangement of claim 1 wherein the said metal rotor consists of a polymer material encased in a metal housing that is a toroidal shape and revolves around a support bearing apparatus with the means of allowing said metal rotor to revolve freely with zero friction resistance.

7. The arrangement of claim 1 wherein the said rotor has at least two sections with an appendage that provides the means for a pathway of very low to zero reluctance for numerous magnetic fields, from the stator coils, to simultaneously flow through.

8. The arrangement of claim 1 wherein any rotating member has a non frictional relationship with any other rotating member of said electric motor.

9. The arrangement of claim 1 wherein more than one section of said rotor are made up of a magnetic material.

10. The arrangement of claim 1 wherein more than one section of said rotor is made up of a dielectric material.

11. The arrangement of claim 1 wherein more than one section of said rotor is made up of a polymer fiber material.

12. The arrangement of claim 1 wherein said rotor is a metal cylinder with gear teeth on its inner surface and said first member is a set of gear wheels rotating around a cylinder shaped member with gear teeth on said cylinder shaped member outer surface and inner surface of said cylinder shaped member circumferences around a turning shaft.

13. The arrangement of claim 1 wherein said third member, which may be a shaft, is permanently fixed to the housing so said third member cannot be moved by the action of any member rotating around said third member, which may be a shaft.
